(19) United States
(12) Patent Application Publication
(10) Pub. No.: US 2007/0267860 A1
(43) Pub. Date: Nov. 22, 2007

(54) Binding Cover Provided with a Less Rigid Strip

(76) Inventor: Ange Tinelli, Chamas (FR)

Correspondence Address: Horst M Kasper, 13 Forest Drive, Warren, NJ, 07059, US

(21) Appl. No.: 10/557,158

(22) PCT Filed: May 14, 2004
(86) PCT No.: PCT/FR04/01174

§ 371 Date: Mar. 6, 2007

(30) Foreign Application Priority Data
May 16, 2003 (FR) 03/05939

(51) Int. Cl. B42D 1/06

(52) U.S. Cl. 281/21.1; 281/15.1

(57) ABSTRACT

The invention relates to a binding board having one of its flanks extended by a rectangular margin. The rectangular margin bears exclusively on one flank of the board and is less rigid than the board. The invention also provides a work bound with two binding boards.

The present invention relates to a binding cover board provided with a margin of reduced rigidity.

The invention lies in the field of bookbinding as a craft, in other words it relates to assembling a pile of leaves. The term “craft” as applied to bookbinding means that the number of copies to be bound is very small, often only one. Several techniques are available for making such an assembly.

A first technique consists in engaging a clip along one of the flanks of the pile of leaves. The clip presents a section in the form of an isosceles trapezoid with its minor base missing. The major base is longer than the thickness of the pile and the small base is shorter. It is the springiness of the clip made of plastics material that holds the pile of leaves together. Generally, the edges of the clip are rounded so that they appear as a spine extended along each edge by an inwardly-directed flange. When a book or other work that has been bound by means of such a clip is stood vertically on a shelf, it does not stand up and collapses onto its bottom corner distant from the bottom corner in the clip. This spoils the work. It might be imagined that a board could be placed on either side of the stack prior to engaging the clip, but since such a board is by its very nature rigid, it would then be very difficult or even impossible to consult the work.

To improve that first technique, U.S. Pat. No. 2,106,511 proposes a binding in the form of a first board extended by a rectangular margin itself extended by a second board. The margin which bears against one of the faces of each of the binding cover boards is less rigid than the boards. It wraps around the shape of the flank presented by the pile of leaves constituting the unbound book. That requires the width of the margin to match the thickness of the pile of leaves. It is therefore necessary to have a considerable number of types of binding available in order to be capable of binding works of different thicknesses. In addition, the thickness of the clip must match the thickness of the pile of leaves, which means that such a device is inconvenient to use.

German patent document No. 32 48 354 C1 presents a single leaf of card constituting two cover boards. The junction between the boards lies in a central zone of thickness that is reduced by milling and that is to form the spine of the bound book. In that case also, it is necessary for the width of the central zone to match the thickness of the unbound book. In addition, the pile of leaves is secured in traditional manner by being glued to a textile strip, which requires special tooling.

U.S. Pat. No. 2,180,965 likewise teaches covering a book without using a clip. That cover is constituted by a sheet having stuck thereto firstly two cover boards, and secondly rigid strips each having a flank following the edge of the cover once in place and another flank adjacent to the flank of the middle cover board. That is a complex arrangement that requires a plurality of elements to be secured to the sheet with great accuracy.

A second technique consists in perforating the pile of leaves and then inserting in the perforations a binder member with a spine in the form of half a circular cylinder. Respective resilient ring segments for penetrating into the perforations in the leaves have one end secured to the edge of the spine and an Opposite end that can be engaged to press against the inside of the half-cylinder. To bind a work, the rings are initially disengaged from the half-cylinder, the pile of perforated leaves is engaged on the rings, and then the rings are released so that they return to their initial positions pressing against the half-cylinder. That type of binding is not very reliable since some of the rings tend to come out from the spine when the work is handled without taking care. That phenomenon would be made worse if the pile were to be provided with a rigid board on each of its faces.

A third technique is proposed by U.S. Pat. No. 4,369,013. There likewise, the pile of leaves is perforated. A first rigid strip carrying transverse studs that are spaced apart at the same pitch as the perforations is engaged with the pile. The studs are longer than the thickness of the pile so that a second rigid strip having openings, likewise spaced apart at the same pitch, is engaged on the free ends of the studs. Once the assembly has been compressed, the ends of the studs are sheared off and flattened so as to become locked in the openings. That type of binding presents a long lifetime. However it suffers the same limitations as the clip mentioned above in the first technique.

The present invention thus seeks to provide a binding device that is very simple, that allows the work to be consulted easily, and that enables it to be stood vertically without becoming damaged.

According to the invention, the binding board has one of its flanks extended by a rectangular margin, that bears exclusively on one face of the board and that is less rigid than the board.

Thus, since the binding is made up using two independent boards, it adapts directly to any type of work, regardless of the thickness of the work. The margin against which any type of binding device can bear acts as a hinge between the spine and the binding board. As a result, firstly the board itself can easily be handled since it is not rigidly connected to the pile of leaves, and secondly, the work can be stood vertically since it is supported by the rigid boards.

Advantageously, the margin is of a thickness that is smaller than that of the flank.

In a first variant, the bottom face of the margin and the bearing face are coplanar.

In a second variant, the top face of the margin and the bearing face are coplanar.

Preferably, the margin is provided with fastener means.

In a preferred embodiment, the fastener means are orifices opening out to both faces of the margin.

The invention also provides a bound work comprising a pile of leaves extending between two boards having margins that are in contact with the pile and that are held by a binder member.

In addition, the margins are provided with fastener means.

In a first option, the binder member is a clip in the form of a spine extended along each of its edges by an inwardly-sloping flange.

In another option, the binder member comprises two rigid strips, one provided with transverse studs and the other with openings in which the studs are locked.

The invention is described in greater detail in the following description of embodiments given by way of illustration and with reference to the accompanying figures, in which:

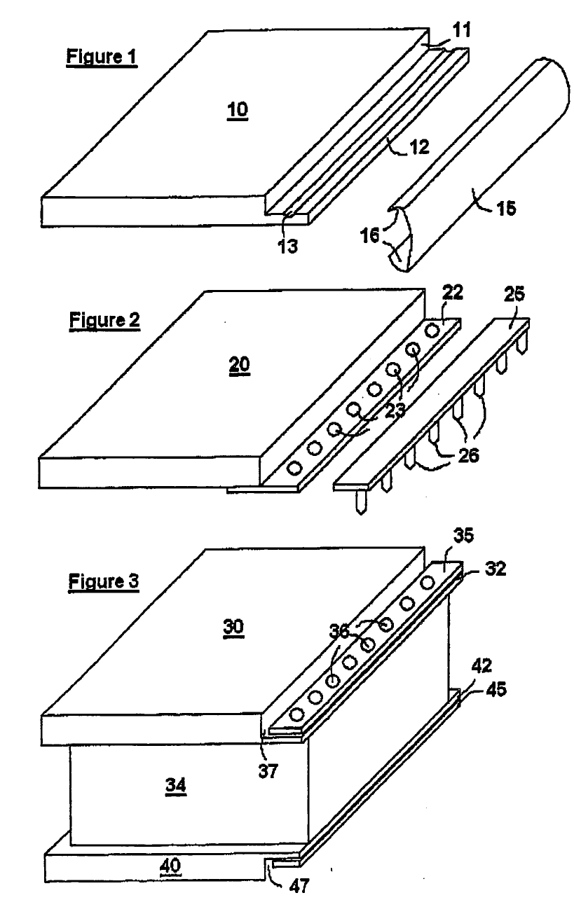

FIG. 1 shows a first binding board associated with a clip;

FIG. 2 shows a second binding board associated with a rigid strip; and

FIG. 3 shows a work bound by using two rigid strips.

With reference to FIG. 1, in a first embodiment, a binding board 10 is in the form of a rectangular parallelepiped provided along one of its flanks 11 with a shoulder leading to a margin 12. The bottom or bearing face of the board 10, and the bottom face of the margin 12 lie in the same plane. The rectangular parallelepiped and the margin constitute a single piece, of final shape that is obtained either directly during manufacture, or by machining an initially rectangular block. The material used is suitable for supporting any type of cover, such as paper, cloth, leather, or more generally any natural or synthetic material capable of supporting writing, gold leaf, printing, or adhesive. This material is commonly cardboard.

The thickness of the rectangular parallelepiped corresponding to the height of its flanks is relatively great, e.g. one to a few millimeters, so that it is indeed rigid. The margin 12 is intended to be much less rigid than the board proper. Given that in the present case both of these elements are made of the same material, the natural technique for obtaining this result consists in causing the thickness of the margin to be significantly smaller than that of the board. For example, this thickness may be of the order of one to a few tenths of a millimeter.

Binding is performed by placing a board 10 on either side of the pile of leaves to be bound, with the bottom faces of the margins 12 coming into contact with the pile along one of its flanks. Thereafter, a clip 15 of the type mentioned above in the first prior art technique is engaged. The flanges 16 of the clip 15 pinch together the margins 12 of the two boards.

A shallow groove 13 may be provided in each of the margins for holding the ends of the flanges 16 of the clip in position. This groove extends parallel to the edges of the margin and of the pile.

With reference to FIG. 2, while retaining the same structure as above, i.e. a rigid board secured to a margin of smaller rigidity, a second embodiment differs somewhat from the first. In this case, the margin 22 is fitted by means of adhesive or any other means to the board 20. The top face of the margin 22 is thus in contact with the bottom face of the board 20.

The fastener means are also different, since they are adapted to rigid strips of the type mentioned above in the third prior art technique. Thus, the pile of leaves is perforated. The margins 22 of the two boards also present perforations 23 at the same pitch as those in the pile, such that the transverse studs 26 of a first rigid strip can be inserted therein.

FIG. 3 shows a work bound in accordance with the invention. A first board 30 provided with its margin 32 is arranged on the top of the pile of leaves 34, this margin 32 thus being positioned so that its bottom face comes into contact with the pile 34 and its outside edge is in alignment with the binding flank of the pile. Similarly, a second board 40 provided with its margin 42 is arranged under the pile 34, this margin 42 thus being positioned so that its bottom face comes into contact with the pile 34 and its bottom edge is in alignment with the binding flank.

A first rigid strip 35, carrying the transverse studs 36, for example, is engaged with the margin 32 of the first board 30. The studs 36 are secured to a second rigid strip 45 provided with openings in which the studs are locked. Preferably, the rigid strips 35, 45 are also positioned so that their outside edges are in alignment with the binding flanks. They are narrower than the margins 32, 42 so as to leave an empty space 37, 47 between the inside edge of each rigid strip 35, 45, remote from its outside edge, and the outside edge of the board 30, 40 extending perpendicularly to the margin 32, 42. These empty spaces 37, 47 make it easy to handle the boards.

The work as shown in the figure is bound using overlapping edges or “squares”, but the invention also applies to a flush binding.

The embodiments of the invention described above have been selected because of their practical nature. Nevertheless, it is not possible to list exhaustively all embodiments covered by the invention. In particular, any means described herein may be replaced by equivalent means without going beyond the ambit of the present invention.

1. (canceled)

2. (canceled)

3. (canceled)

4. (canceled)

5. (canceled)

6. (canceled)

7. (canceled)

8. (canceled)

9. (canceled)

10. (canceled)

11. A binding board 10, 20, 30, 40, characterized in that one of its flanks is extended by a rectangular margin 12, 22, 32, 42, this margin bearing exclusively on one face of said board and being less rigid than the board.

12. A board according to claim 1, characterized in that said margin 12, 22, 32, 42 is of thickness smaller than the height of said board.

13. A board according to claim 1, characterized in that the bottom face of said margin 12, 32, 42 and said bearing face are coplanar.

14. A board according to claim 2, characterized in that the bottom face of said margin 12, 32, 42 and said bearing face are coplanar.

15. A board according to claim 1, characterized in that its top face of said margin 22 and said bearing face are coplanar.

16. A board according to claim 2, characterized in that its top face of said margin 22 and said bearing face are coplanar.

17. A board according to claim 1, characterized in that said margin 12, 22, 32, 42 is provided which fastener means 13, 23.

18. A board according to claim 2, characterized in that said margin 12, 22, 32, 42 is provided with fastener means 13, 23.

19. A board according to claim 3, characterized in that said margin 12, 22, 32, 42 is provided with fastener means 13, 23.

20. A board according to claim 4, characterized in that said margin 12, 22, 32, 42 is provided with fastener means 13, 23.

21. A board according to claim 5, characterized in that said margin 12, 22, 32, 42 is provided with fastener means 13, 23.

22. A board according to claim 6, characterized in that said margin 12, 22, 32, 42 is provided with fastener means 13, 23.

23. A board according to claim 7, characterized in that said fastener means are orifices 23 opening out into both faces of said margin.

24. A board according to claim 8, characterized in that said fastener means are orifices 23 opening out into both faces of said margin.

25. A board according to claim 9, characterized in that said fastener means are orifices 23 opening out into both faces of said margin.

26. A board according to claim 11, characterized in that said fastener means are orifices 23 opening out into both faces of said margin.

27. A work comprising a pile 34 of leaves extending between two boards 10, 20, 30, 40 according to any one of claims 1 to 4, the work being characterized in that the margins 12, 22, 32, 42 of said boards 10, 20, 30, 40 are in contact with the pile 34 and are hold in place by a binder member 15, 25, 35-45.

28. A work according to claim 17, characterized in that said margins 12, 22, 32, 42 are provided with fastened means 13, 23 that co-operate with said binder member 15, 25, 35-45.

29. A work according to claim 18, characterized in that said binder member is a rigid strip 15 in the form of a spine extended on each of its edges by an inwardly-sloping flange 16.

30. A work according to claim 18, characterized in that said binder member comprises two rigid strips, one of the rigid strips 35 being provided with transverse studs 26 and the other with openings in which said studs are locked.
